(19) United States
(12) Patent Application Publication
(10) Pub. No.: US 2014/0363250 A1
(43) Pub. Date: Dec. 11, 2014

(54) MULTI-TOOL MACHINING SYSTEM

(71) Applicant: CBT Technology Inc., Randolph, MA (US)

(72) Inventor: Brian Henry Josephs, Bridgewater, MA (US)

(21) Appl. No.: 13/915,415

(22) Filed: Jun. 11, 2013

(51) Int. Cl. B23C 3/13; B23C 1/08; B23C 1/00

(52) U.S. Cl. CPC B23C 3/13; B23C 1/002; B23C 1/08; B23C 2210/40; B23C 2270/027; B23C 2270/022; B23C 2270/08
USPC 409/173; 409/189

(57) ABSTRACT

A multi-tool system uses precision alignment features to align and attach a group of rotary end mill tools to a gantry. Once attached, a bed with similarly positioned alignment features can be used to align and a number of substantially identical work pieces for fabrication with substantially identical features.

### BACKGROUND

Vented front panels for telecommunications enclosures are growing in popularity. In a typical front panel, vent patterns such as densely packed hexagons or polygons can provide a desirable combination of electromagnetic interference shielding and sufficient airflow for component cooling; however, such front panels are not standardized, so the shapes and vent patterns vary from customer to customer. Mass production of front panels meeting varying customer specifications presents a continuing challenge.

While a suitably shaped, rugged work piece for a front panel can be quickly fabricated from a length of extruded aluminum, the venting geometry is orthogonal to the extrusion axis, and venting features must be added to an extruded part in a post-processing step. In this context, existing manufacturing processes such as waterjet cutting, stamping, and photo-etching are poor solutions for fabricating high-quality parts in volume. These processes are slow, particularly for metals having a thickness of several millimeters as typically found in front panels, and they can mar aesthetically desirable finishes, thus implicating additional polishing/finishing steps or the complication of masks to protect surface finishes during cutting.

There remains a need for multi-tool cutting systems suitable for use with aluminum or similar materials in a high-throughput, customizable fabrication process.

### SUMMARY

A multi-tool system uses precision alignment features to align and attach a group of rotary end mill tools to a gantry. Once attached, a bed with similarly positioned alignment features can be used to align and a number of substantially identical work pieces for fabrication with substantially identical features.

### BRIEF DESCRIPTION OF THE DRAWINGS

The invention and the following detailed description of certain embodiments thereof may be understood by reference to the following figures:

FIG. 1 shows a multi-tool machining system.

FIG. 2 shows a multi-tool machining system.

FIG. 3 is a front view of a multi-tool fixture positioned over an alignment fixture.

FIG. 4 is a side view of a multi-tool fixture.

FIG. 5 is a top view of a spring mechanism.

FIG. 6 is a perspective view of a spring mechanism.

FIG. 7 shows a spring mechanism positioned to bias a work piece.

FIG. 8 shows a multi-tool machining system with multiple cutting stations.

FIG. 9 shows a method for multi-tool machining

### DETAILED DESCRIPTION

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus the term “or” should generally be understood to mean “and/or” and so forth.

Where numerical values are provided, they are generally intended as non-limiting examples unless otherwise stated. Terms such as “about” or “substantially” are intended to accommodate a degree of variability or imprecision consistent with the operating principles of the systems and methods described below such as would be readily appreciated and accepted by one of ordinary skill in the art. Thus for example, where two different groups of tools are described as having substantially identical alignment, it is intended that the alignment between the two groups be sufficiently close that a corresponding group of work pieces arranged in an alignment fixture or the like can be transferred from one group of tools to the other for additional machining without observable differences in the results from work piece to work piece. Of course, the actual precision required will depend on the specification and tolerances for the work pieces, the overall size of the work pieces, the size of each machined feature, and so forth. As such, specific numeric values are not provided in this context. Rather, one of ordinary skill in the art can readily ascertain suitable tolerances for substantially identical tool positioning in a particular machining process. As another example, a substantially horizontal surface for machining work pieces will be understood to describe a surface that provides sufficient regularity through an x-y plane for consistent z-axis machining results from work piece to work piece. More generally, where relative terms are used below, such terms are specifically intended to accommodate the ordinary variability found in machining systems or other similar physical systems.

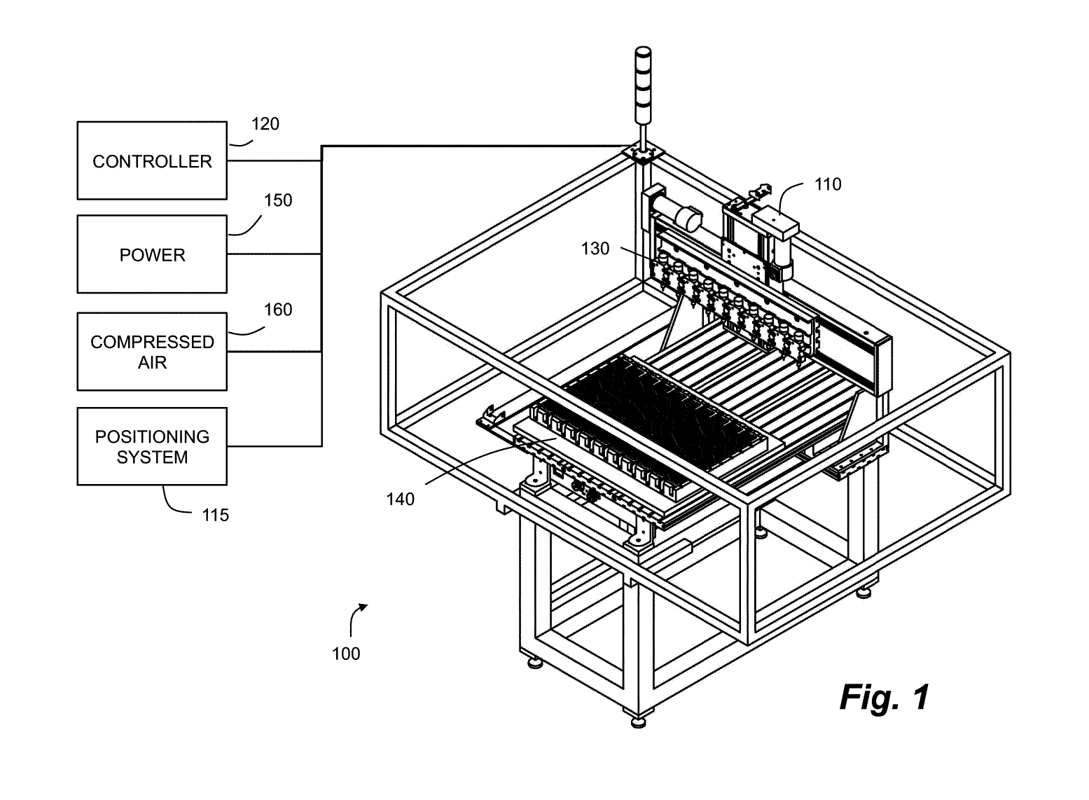

FIG. 1 shows a multi-tool machining system. In general, the system 100 may include a gantry 110, a controller 120, a fixture 130, an alignment fixture 140, a power source 150, and a compressed air source 160.

The gantry 110 may be any gantry suitable for controlling x, y, and z-axis movement of the fixture 130 relative to the alignment fixture 140. This may include a Cartesian gantry as illustrated, which can advantageously provide substantial resistance to stress-induced rotations that might otherwise occur during machining of metals or the like. Other positioning systems may be used including without limitation robotic arms, sliding members, worm gears, stepper motors, and the like or any other components or combinations of components suitable for moving the fixture 130 about in three-dimensional space under control of the controller 120. More generally, the gantry 110 may control a position and an orientation of each tool coupled thereto, and may be configured to control the position and/or orientation of each such tool collectively (i.e., so that they all change position and orientation together) or independently (e.g., so that a single tool can be moved up and down or shifted to a different orientation relative to the z-axis).

The system 100 may include a positioning system 115 for further control of tool movement and positioning relative to the gantry 110. For example, the positioning system 115 may be a relative positioning system for adjusting a position of one of the number of rotary cutting tools relative to one or more other ones of the number of rotary cutting tools. In this manner a single tool may move independently, for example to disengage the tool from a machining procedure with a z-axis movement or lift, or by changing an x-y position of the tool relative to other tools on the gantry. The positioning system may also or instead include an orientation system for concurrently adjusting an orientation of each of the number of rotary cutting tools relative to a z-axis of the gantry, or for independently adjusting an orientation of one of the number of rotary cutting tools.

The controller 120 may be coupled in a communicating relationship with the gantry 110 and configured to control operation of the gantry 110 in response to gantry-executable machine code. More generally, the controller 120 may be coupled in a communicating relationship with the gantry 110 and other controllable components of the system 100 to control the use of these components in the system 100 for multi-tool machining as contemplated herein. The controller 120 may execute machine code and create corresponding control signals to control electromechanical components of the gantry 110 and associated machinery (e.g., the compressed air source 160 or rotary tools) to perform various machining operations, such as to mill or otherwise machine work pieces secured to the alignment fixture 140. The controller 120 may be a standalone, programmable device installed on the system 100, or the controller 120 may include a remote computer that provides a user interface to program the system 100, or some combination of these. For example, the controller 120 may include a desktop computer coupled to the controller 120 through a local network. In another aspect, the controller 120 may include a port for a removable memory such as a Universal Serial Bus device or a memory stick that can be used to transfer machine code from a computer workstation or the like to a local memory of the controller 120 for execution.

The fixture 130 may be coupled to the gantry 110 and may provide a mechanical interface for coupling tools and the like to the gantry.

The alignment fixture 140 may include a bed or other surface including various grooves, notches, or other registration features that receive and retain work pieces for machining by the system 100.

The power source 150 may include any fixed alternating current or direct current power supply used to power components of the system 100. The power source 150 may also or instead include a controllable power source such as a controllable voltage source, a controllable current source, a controllable pulse width modulated electrical source, and so forth, which may be used, for example, to control a rotation speed of rotary tools, a position of gantry motors, or any other aspects of the system 100 under control of the controller 120.

Where the system 100 includes pneumatically-driven rotary tools or the like the system 100 may also include a compressed air source 160 that can be used to controllably drive the pneumatic components, e.g., under control of the controller 120.

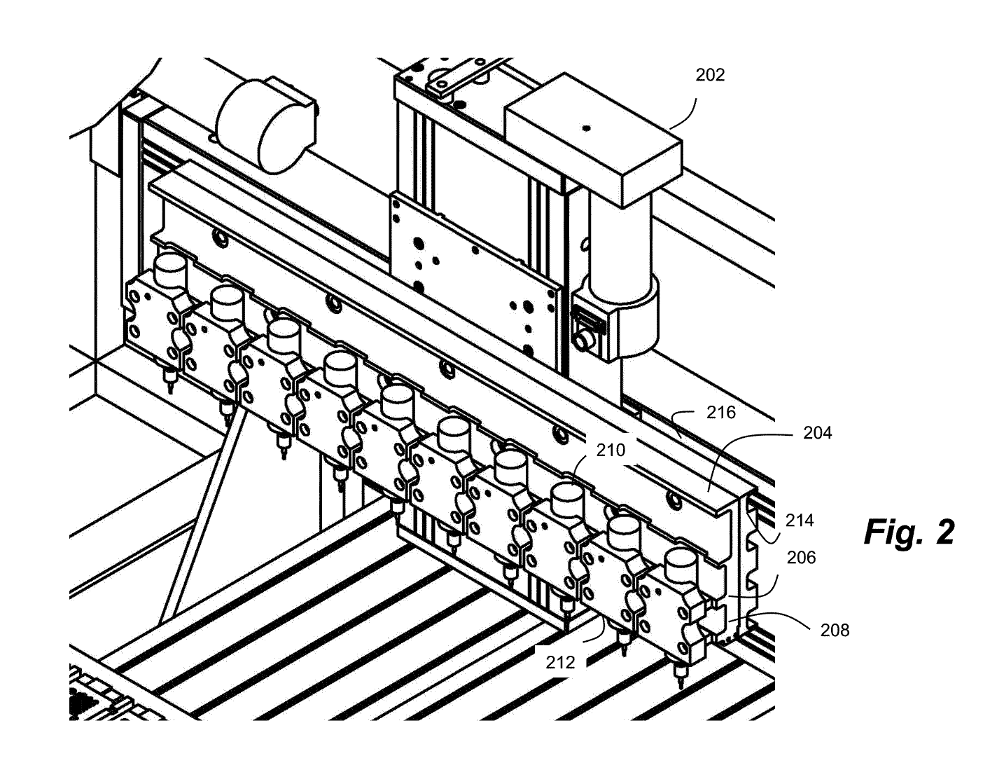

FIG. 2 shows a multi-tool machining system. In particular, FIG. 2 shows a close-up view of a gantry 202 having a fixture 204 with a mounting surface 206 including a number of registration features 208 to retain rotary tools 210 in a predetermined arrangement relative to the gantry 202.

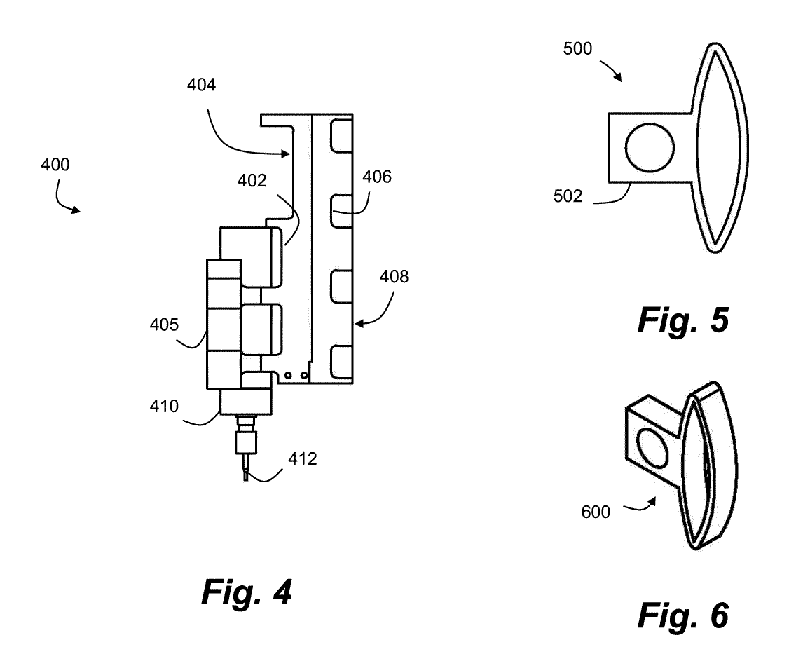

In one aspect, the mounting surface 206 of the fixture 204 may include registration features 208 such as a number of horizontal grooves or the like (see FIG. 4) to slideably secure one or more rotary tools in a predetermined z-axis position. Machine screws or the like may be used to secure the rotary tools to the mounting surface 206, either at predetermined locations, e.g., using threaded holes in the mounting surface 206, or in arbitrary locations using, e.g., set screws to frictionally engage the rotary tools to a channel or the like provided in the horizontal grooves or similar registration features. Other mechanisms such as clamps or the like may also or instead be used to retain the rotary tools, provided that such mechanisms secure the rotary tools with sufficient tenacity for the milling processes contemplated herein.

The system may include a number of rotary tools 210 secured in a predetermined arrangement on the fixture 204. It will be appreciated that any shape, size, or arrangement of registration features may be suitably employed, provided that the rotary tools 210 are configured with corresponding registration features to securely affix to the mounting surface 206 in desired locations. Each rotary tool 210 may be secured in an enclosure 212 that has been precision milled from aluminum or the like to securely retain the rotary tool 210 and provide mounting points for securing the rotary tool 210 to the fixture 204. By closely matching the curvature of the enclosure 212 to an outside diameter of the rotary tool 210, the rotary tool 210 may be securely clamped along a majority of its exterior without mechanically compromising operation of the rotary tool 210. A number of pneumatically-driven and electrically-driven rotary tools are commercially available with relatively narrow diameters (e.g. about one to two inches) to facilitate closed spacing along the mounting surface 206, and correspondingly close spacing of work pieces affixed to an alignment fixture or other bed upon which the work pieces are machined. Where closer spacing is required, the tools may be staggered in an x or y axis of the mounting surface 206, and alignment features within the mounting surface 206 may be staggered by substantially the same amount to properly position corresponding work pieces relative to the rotary tools 210.

The fixture 204 may include another registration feature 214 adapted to secure the fixture 204 to the gantry 202 in a predetermined alignment. This may for example include a registration feature 214 on a back surface opposing the mounting surface 206, This registration feature 214 may include grooves or the like to slideably secure the fixture 204 at a predetermined z-axis position within the gantry 202, or this may include any other alignment feature(s) to secure the fixture 206 to the gantry 202 at a predetermined location in one, two, or three dimensions. A variety of suitable alignment features are known in the art and may be adapted for use with the fixture 204 described herein. The fixture 204 may advantageously be removably and replaceably mounted to a mounting surface 216 of the gantry 202 to facilitate use of multiple fixtures, such as fixtures that provide different tool types, different tool spacings, and other configurations. The fixture may be removably and replaceably coupled to the mounting surface 216 by a number of machine screws, one or more clamps, or any other suitable mechanism(s).

A gantry 202 with rotary tools 210 such as air spindles using carbide end mills secured to an aluminum mounting structure has been demonstrated to concurrently machine ten different aluminum work pieces of up to three millimeters in thickness to provide a hexagonal pattern separated by a webbing of 0.005 inches of unmilled material. As distinguished from jet cutting techniques and the like, processing speed is maintained largely independent of material thickness, and the process has been usefully demonstrated on aluminum parts having a ratio of material thickness to webbing of about 12.5:1. The general configuration is extensible using commercially available gantry systems to concurrently drive additional tools, and may, for example, include five tools, ten tools, fifteen tools, or any other suitable number of tools.

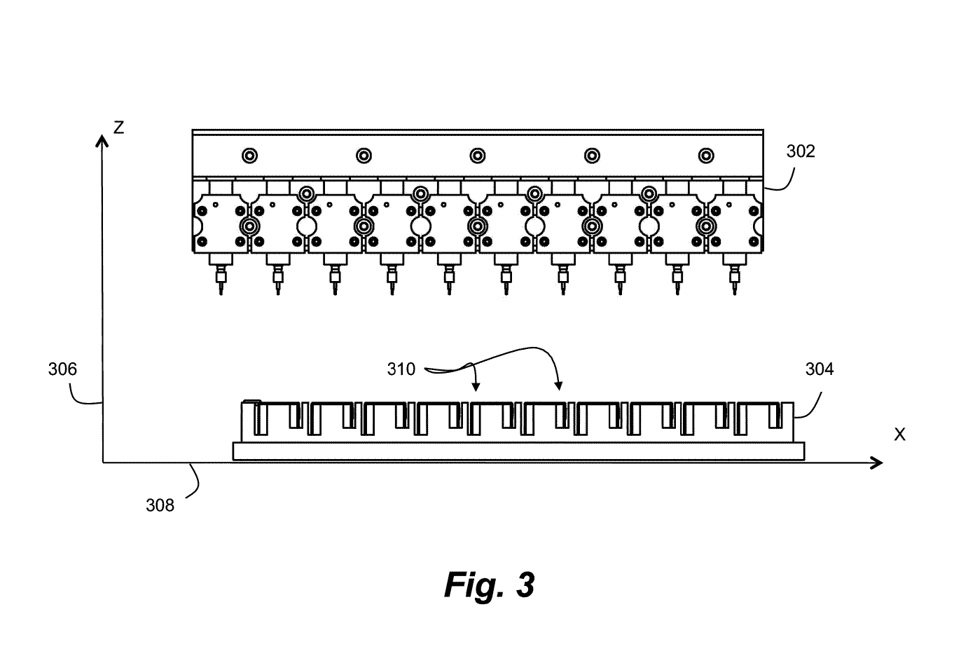

FIG. 3 is a front view of a multi-tool fixture positioned over an alignment fixture. Although not depicted, it will be understood that a gantry such as any of the gantries described above may couple the multi-tool fixture 302 to the alignment fixture 304 to permit relative x-y-z positioning of the multi-tool fixture 302 and the alignment fixture 304, such as for controlled machining or the like. A z axis 306 and an x axis 308 are also depicted to show a typical coordinate system for a gantry, where a z-axis movement is along the z axis 306, i.e., toward or away from an x-y plane of the alignment fixture 304.

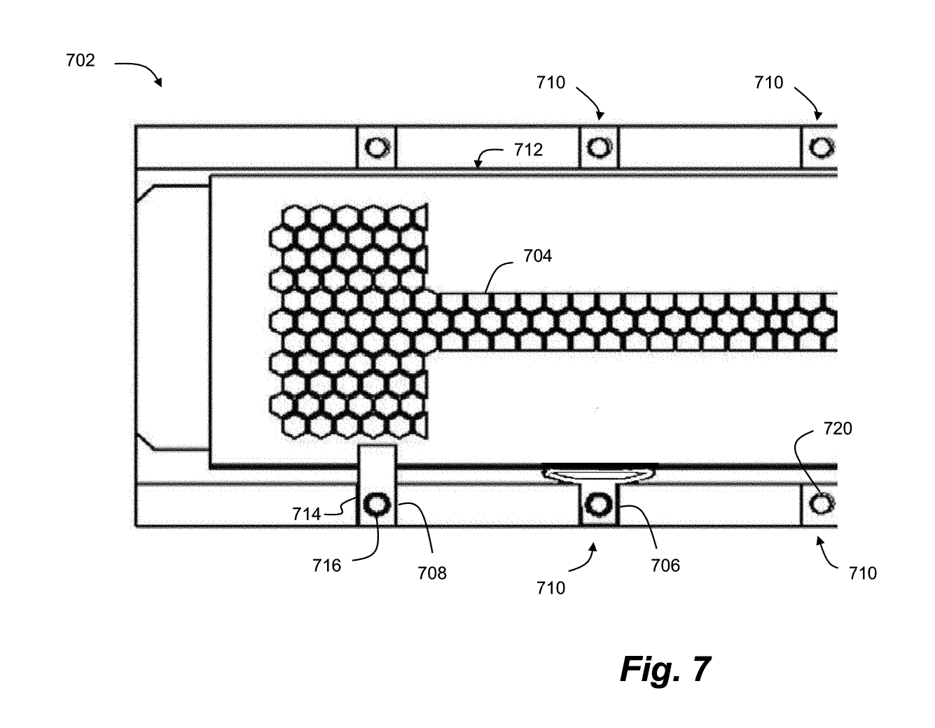

In general, the alignment fixture 304 may include a number of recesses 310 such as grooves or other openings adapted to loosely retain a number of work pieces in a corresponding number of predetermined alignments relative to each one of the rotary cutting tools or other tools on the multi-tool fixture 302. The alignment fixture 304 may also include a number of secondary recesses (see recesses 710 in FIG. 7) adjacent to the number of recesses 310 to receive hardware for aligning and securing work pieces to the alignment fixture 304. The alignment fixture 304 may be formed of a bed of material, e.g., an easily machinable material such as a soft metal or plastic, so that recesses 310 and other alignment features can be directly machined into the alignment fixture 304 with the multi-tool fixture 302 and gantry. This technique advantageously ensures that the tools to perform machining are properly aligned (after milling alignment features) to the bed that retains work pieces, and more particularly, that each tool will be identically aligned to one of the work pieces placed into the alignment fixture 304.

FIG. 4 is a side view of a multi-tool fixture. FIG. 4 depicts an exemplary embodiment of a multi-tool fixture 400 having a first set of registration features 402 such as horizontal grooves or channels on a mounting surface 404 to receive rotary tools (each secured in an enclosure 405) in a predetermined orientation and/or position. The multi-tool fixture 400 may also include a second set of registration features 406 such as horizontal grooves or channels on a second surface 408 for coupling to a gantry or other control system in a predetermined position/orientation.

The rotary cutting tools 410 in the multi-tool fixture 400 may, for example be pneumatically-driven or electrically-driven rotary tools such as any of a variety of commercially available air spindles. These tools may be driven by a source of pressurized air, such as the compressed air source described above, which may be configured to selectively supply the pressurized air to the rotary cutting tools (individually or collectively) under control of the controller. The rotary cutting tools 410 may also or instead include electrically-driven rotary tools or any other rotary powered tool(s). Each rotary cutting tool 410 may include a bit 412 such as a drill bit, end mill, or other cutting surface removably and replaceably secured in a chuck of the rotary cutting tool 410. For example, the rotary cutting tool 410 may include a carbide end mill, a single flute end mill, or a combination of these.

The multi-tool fixture 400 may be fabricated of any suitably rigid material. For example, aluminum may be milled with sufficient precision to provide suitable alignment and registration features as contemplated herein, and also provides sufficient strength to rigidly support a number of rotary tools during the stresses typically associated with milling processes.

FIG. 5 is a top view of a spring mechanism. The spring mechanism 500 may, for example, be a dual beam flat spring cut from high-density polyurethane or other flexible, resilient material or the like with a stem 502 shaped and sized to fit into a corresponding feature of an alignment fixture such as any of the alignment fixtures described above. While the dual beam flat spring of FIG. 5 may be conveniently fabricated using a laser cutting process or the like, a variety of other spring mechanisms are known in the art and may be suitably adapted to horizontally bias work pieces within a fixture as described below.

FIG. 6 is a perspective view of a spring mechanism 600 such as the spring mechanism described above.

FIG. 7 shows a spring mechanism positioned to bias a work piece. As noted above a number or secondary recesses 710 may be provided in an alignment fixture 702 to align components other than work piece 704 such as the spring mechanism described above. The secondary recesses 710 may, for example, include recessed channels within the alignment fixture shaped and sized to securely retain a portion of a spring mechanism in a predetermined orientation. Thus the system may include at least one spring mechanism 706 shaped and sized to fit into one of the secondary recesses 710 and biased to apply a horizontal force (when positioned in one of the secondary recesses 710) urging one of the work pieces 704 into an aligned position such that the work piece 704 is in a secure engagement with a vertical wall 712 of one of the recesses. For example, the spring mechanism 706 may fit into one of the secondary recesses 710 and apply a horizontal, lateral force to bias the work piece 704 toward the vertical wall 712 of a retaining edge of a groove or other alignment feature in the alignment fixture 702. Any number of spring mechanisms 706 may be inserted along the work piece 704. For example, two spring mechanisms 706 near opposing ends of the work piece 704 along an alignment groove may help to reduce rotational misalignment of the work piece 704 within the alignment groove. Further, where multiple work pieces are being handled, the secondary recesses 710 may be repeated in suitable, corresponding locations for each such work piece. In this manner the alignment features of the alignment fixture may loosely retain work pieces for quick and easy placement and removal, while the spring mechanisms provide more accurate alignment to the alignment fixture for precision machining

A positive locking mechanism 708 may also or instead be used to secure the work piece 704. The positive locking mechanism may for example include a tab 714 that extends over a top of the work piece 704 and a machine screw 716 to securely mechanically retain the positive locking mechanism 708 to the alignment fixture 702 and work piece 704. The positive locking mechanism 708 may be shaped and sized to fit into one of the secondary recesses 710, which may be one of the grooves illustrated or some other alignment feature such as a threaded hole in the alignment fixture 702. Thus in one aspect the alignment fixture 704 may include a threaded hole 720 and the positive locking mechanism 708 may include a machine screw 716 fitted to the threaded hole 720. The positive locking mechanism(s) 708 may be used in combination with the spring mechanism(s) 706. For example, the positive locking mechanism 708 may be applied to the one of the work pieces 704 after the work piece 704 is aligned to the fixture 704 with at least one spring mechanism 706.

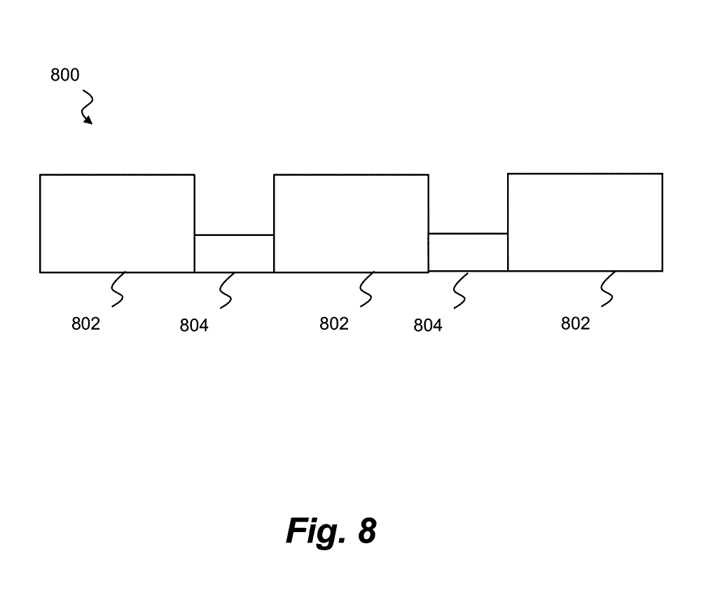

FIG. 8 shows a multi-tool machining system with multiple cutting stations. The system 800 may include a plurality of cutting stations 802, each having a group of rotary cutting tools such as any of the systems and tools described above. In general, the group of tools in each cutting station 802 may have a substantially identical relative alignment of tools to each other one of the cutting stations 802. Configured in this manner, a palate or tray of work pieces may be moved from cutting station 802 to cutting station 802, and each cutting station 802 may perform an identical machining operation on each of the work pieces concurrently.

A conveyor system 804 may be provided to move a group of work pieces from one of the cutting stations 802 to another one of the cutting stations 802. The conveyor system 804 may be automatic, manual, or some combination of these, and may include belts, robotic arms, and so forth to move a group of work pieces from one cutting station 802 to the next. Any number of cutting stations 802 may be arranged sequentially to facilitate a sequence of machining steps. This may, for example, facilitate the use of multiple different cutting tools such as end mills of different diameters, different shapes (e.g., with angled or rounded profiles for finishing edges) and the like. The cutting stations 802 may also include tools for de-burring, polishing, or other finishing steps.

Other arrangements of tools are also possible. For example, a single cutting station may include a first group of rotary cutting tools secured in a predetermined arrangement relative to one another, and a second number of rotary cutting tools secured in a position relative to one another that is substantially identical to the predetermined arrangement of the first group of rotary cutting tools. The second group of rotary cutting tools may include a different end mill than the first group of rotary cutting tools, such as a drill of a different diameter. A gantry such as any of the gantries described above may include a mechanism to independently raise and lower the first and second groups of rotary cutting tools—that is, move the second group in the z axis independently from the first group—so that the two groups can be used alternately (or in some embodiments, concurrently) on a group of work pieces retained in an alignment fixture or the like. More generally, any additional or alternative control mechanisms may be suitably employed with the systems described herein to adapt the system to a variety of multi-tool machining tasks, all without departing from the scope of this disclosure.

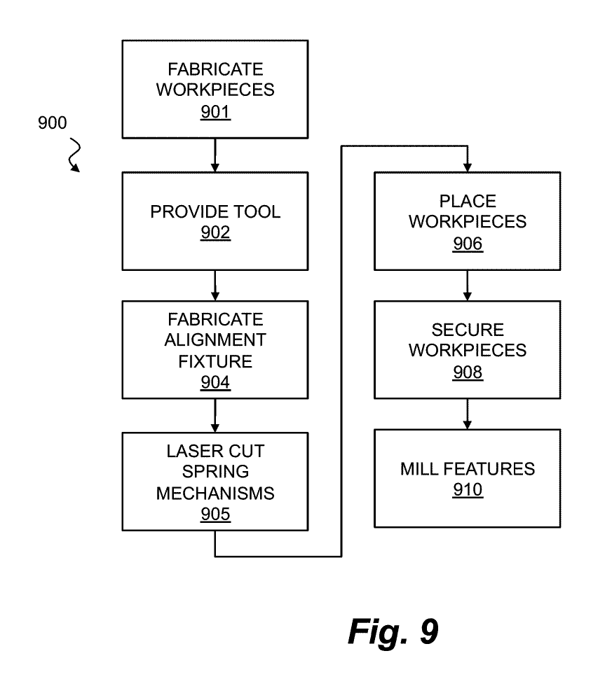

FIG. 9 shows a method for multi-tool machining as contemplated herein.

As shown in step 901, the method 900 may begin with fabricating a number of work pieces. This may, for example, include extruding aluminum with a desired cross section and cutting to length for an intended use (e.g., as a front panel for an electronics enclosure). This may also or instead include cutting, punching, and/or bending a shape from a sheet of steel such as stainless steel, or machining the shape from a block of metal. While any source of work pieces may be employed, aluminum extrusion provides a convenient technique for sourcing durable and aesthetically pleasing work pieces in high volume with a uniform cross-sectional shape. Machining techniques described herein may then be used to create additional features in each work piece orthogonal to the extrusion axis, or for pieces fabricated from sheet metal, orthogonal to a principal plane of the work piece.

As shown in step 902, the method 900 may include providing a tool having a number of rotary end mills with a fixed, predetermined spatial relationship to one another. This may, for example, include a number of pneumatically-drive air spindles or other rotary tools fixed in a predetermined relationship to one another as generally described above. A variety of rotary end mills may be usefully employed, including without limitation at least one carbide end mill, at least one single flute end mill, or a combination of these. The each rotary end mill may also include a rotary drive system such as a pneumatically-driven rotary tool or an electrically-driven rotary tool.

As described above, providing the tool may include removably and replaceably securing each of the number of rotary end mills to an alignment fixture that enforces the fixed, predetermined spatial relationship. The alignment fixture may itself include at least one alignment feature to align the fixture to a gantry or other positioning system, and step 902 may also include securing the alignment feature to a gantry in an alignment enforced by the alignment feature. In this manner, a set of rotary tools may be conveniently installed and removed so that a variety of different sets of rotary tools can be used interchangeably on a single gantry or similar system.

As shown in step 904, the method 900 may include fabricating an alignment fixture. In general, the alignment fixture will have a number of alignment features having the same fixed, predetermined spatial relationship to one another as the multi-tool system. A variety of techniques may be used to fabricate such an alignment fixture. For example, this may include milling the alignment fixture directly into a bed with the multi-tool system, more specifically by controlling a position of the rotary end mills with an x-y gantry such as any of the gantries described above, and/or controlling a depth of the rotary end mills using a z-axis mechanism of an x-y-z gantry. In this manner, the alignment of the end mills ensures a resulting similar alignment of features in the alignment fixture, and thus similarly ensures a corresponding alignment of work pieces that are placed in the fixture to the cutting tools.

Other techniques may also or instead be employed. For example, a bed or other alignment fixture may be designed in a computer aided design environment and fabricated using any suitable rapid prototyping system. As another example, a second multi-tool system having the same predetermined tool alignment may be used to fabricate the alignment fixture. In this way, fabrication of the alignment fixture may be performed independently from a manufacturing line that uses the alignment fixture, so that the fabrication line can be more quickly changed from one process to another.

The number of alignment features in a fixture may, for example, include at least one feature to receive a spring mechanism that biases one of a number of substantially identical work pieces toward a predetermined location within the alignment fixture. The number of alignment features may also include one or more features to retain a positive locking mechanism as described above.

As shown in step 905, the method 900 may include laser-cutting a spring mechanism shaped and sized to bias one of the number of work pieces toward a predetermined position within the alignment fixture. In this manner, custom spring mechanisms for a particular machining operation may be conveniently manufactured for each work piece/fixture combination using readily available rapid prototyping technology. The spring mechanism may, for example, be the dual beam flat spring such as that illustrated above. It will be appreciated that other laser-cuttable spring shapes may also be used, or other spring types such as coil springs, machines springs, spring washers, wave springs, and so forth. More generally, the spring mechanism may be any spring mechanism suitable for horizontally biasing a work piece into a desired orientation as discussed above.

As shown in step 906, the method 900 may include placing a number of substantially identical work pieces into the number of alignment features. Thus the work pieces may be arranged on a bed in a manner that corresponds to the locations of the number of rotary tools. This may include automatic placement, manual placement, or some combination of these.

As shown in step 908, the method 900 may include securing the number of work pieces to the bed. For example, an insertable spring such as one of the springs described above may be inserted into the alignment fixture to bias a work piece toward a retaining wall or the like where the work piece is held in a correctly aligned position for machining Thus the method may include a step of inserting the spring mechanism into the at least one feature, thereby biasing the one of the number of substantially identical work pieces toward a predetermined location within the alignment fixture.

It will be appreciated that the ability of a spring mechanism to retain a work piece against the relatively strong rotary and linear forces of machining is somewhat limited, particularly when machining a thick layer of metal or the like (e.g., three millimeter thick aluminum). As such, the number of alignment features may also include at least one feature to receive a positive locking mechanism to secure one of the number of substantially identical work pieces in a predetermined location within the alignment fixture, and the method may include inserting the positive locking mechanism into the at least one feature and securing in place, thereby positively securing the one of the number of substantially identical work pieces in a predetermined location within the alignment fixture. In general, it is contemplated that the positive locking mechanism may be any mechanism that can retain a work piece in a fixed location within the alignment fixture against the forces of milling, and the degree of positive locking required for a particular work piece will vary according to the intended machining steps to which the work piece will be subjected.

As shown in step 910, the method may include milling a through-hole feature into each of the number of work pieces concurrently with the number of rotary end mills. It will be understood that a through-hole feature may have any cross-sectional shape (within the x-y plane of a gantry or the like), and may be circular, triangular, square, rectangular, hexagonal, and so forth. Certain shapes such as square, triangular, or hexagonal shapes can be arranged to minimize interstitial webbing, and may be advantageously employed in applications where venting, or more generally open space, is desired between opposing surfaces of a work piece. More generally, any regular or irregular geometries may be employed according to a particular application. Further, while through-hole features are specifically contemplated for venting, other features may be usefully machined that do not pass entirely through a work piece, and all such features that might be machined concurrently in a number of substantially identical work pieces are intended to fall within the scope of this disclosure.

Thus, while the systems and methods disclosed herein were conceived for use in mass-producing hexagonal vent arrays in extruded aluminum components, it will be understood that any other through-hole feature(s) or other surface features may also or instead be fabricated concurrently in a number of parts including without limitation circular holes, square openings and the like, which may be used to accommodate switches, light-emitting diodes, or other components that might be usefully included in a front panel for an electronics enclosure. Thus, the method 900 may include milling any number of through-hole features into each of the number of work pieces with the number of rotary end mills.

The method 900 may also include milling a second set of through-hole features into each of the number of work pieces with a second number of rotary end mills, using e.g., a second group of tools on a gantry or a second cutting station as described above. The second number of rotary mills may have a different shape and/or size than the other rotary mills. For example, the number of rotary mills may have a second diameter different from the number of rotary end mills in order to facilitate cutting of different shapes or patterns, or cutting features having significantly different sizes.

The methods above are provided by way of example. Absent an explicit indication to the contrary, the disclosed steps may be modified, supplemented, omitted, and/or re-ordered without departing from the scope of this disclosure.

The method steps of the invention(s) described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps.

While particular embodiments of the present invention have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

1. A system comprising:
a gantry having a mounting surface with a first registration feature;
a controller coupled in a communicating relationship with the gantry and configured to control operation of the gantry in response to gantry-executable machine code;
a number of rotary cutting tools secured in a predetermined arrangement on a fixture having a second registration feature, wherein the second registration feature is adapted to secure the fixture to the gantry in a predetermined alignment and wherein the fixture is removably and replaceably coupled to the mounting surface of the gantry;
an alignment fixture including a number of recesses adapted to loosely retain a number of work pieces in a corresponding number of predetermined alignments relative to each one of the rotary cutting tools, the alignment fixture further including a number of secondary recesses adjacent to the number of recesses; and
at least one positive locking mechanism shaped and sized to fit into one of the secondary recesses and configured to securely mechanically retain the one of the work pieces in an aligned position in the alignment fixture wherein the one of the work pieces is in a secure engagement with a vertical wall of one of the number of recesses.

2. The system of claim 1 further comprising at least one spring mechanism shaped and sized to fit into a second one of the secondary recesses and biased to urge one of the work pieces into the aligned position.

3. The system of claim 2 wherein the at least one positive locking mechanism is applied to the one of the work pieces after the one of the work pieces is aligned to the fixture with the at least one spring mechanism.

4. The system of claim 2 wherein the at least one spring mechanism includes a dual beam flat spring.

5. The system of claim 2 wherein the at least one spring mechanism horizontally biases the one of the work pieces toward a vertical wall of the alignment fixture.

6. The system of claim 1 wherein the fixture is removably and replaceably coupled to the mounting surface by a number of machine screws.

7. The system of claim 1 wherein the fixture is removably and replaceably coupled to the mounting surface by one or more clamps.

8. The system of claim 1 wherein the gantry includes an x-y-z gantry.

9. The system of claim 1 wherein the rotary cutting tools include pneumatically-driven rotary tools.

10. The system of claim 9 further comprising a source of pressurized air coupled to each of the rotary cutting tools and configured to selectively supply the pressurized air to the rotary cutting tools under control of the controller.

11. The system of claim 1 wherein the rotary cutting tools include electrically-driven rotary tools.

12. The system of claim 1 wherein the rotary cutting tools includes an end mill.

13. The system of claim 12 wherein the end mill is at least one of a single flute end mill and a carbide end mill.

14. The system of claim 1 wherein the fixture includes a threaded hole and the at least one positive locking mechanism includes a machine screw fitted to the threaded hole.

15. The system of claim 1 further comprising a plurality of cutting stations each including a group of rotary tools having a substantially identical relative alignment of tools to each other one of the plurality of cutting stations.

16. The system of claim 15 further comprising a conveyor system to move a group of work pieces from one of the plurality of cutting stations to another one of the plurality of cutting stations.

17. The system of claim 1 further comprising a relative positioning system for adjusting a position of one of the number of rotary cutting tools relative to one or more other ones of the number of rotary cutting tools.

18. The system of claim 1 further comprising an orientation system for concurrently adjusting an orientation of each of the number of rotary cutting tools relative to a z-axis of the gantry.

19. The system of claim 1 further comprising a second number of rotary cutting tools secured in a position relative to one another substantially identical to the predetermined arrangement of the number of rotary cutting tools, wherein the second number of rotary cutting tools include a different end mill than the number of rotary cutting tools and wherein the gantry can move the second number of rotary cutting tools in the z-axis independently from the number of rotary cutting tools.

20. The system of claim 1 wherein the at least one positive locking mechanism includes a tab overlapping the one of the work pieces and a machine screw to secure the tab to the alignment fixture.

21. The system of claim 1 wherein the alignment fixture is milled into a bed of material using the gantry and the number of cutting tools.

22-41. (canceled)
